(19) United States
(12) Patent Application Publication
(10) Pub. No.: US 2015/0264859 A1
(43) Pub. Date: Sep. 24, 2015

(54) PLANT GROWING DEVICE

(71) Applicant: MICROGROWER LTD, Antrobus, Cheshire (GB)

(72) Inventor: Brian James Morrissey, Wychwood Park (GB)

(21) Appl. No.: 14/436,197

(22) PCT Filed: Oct. 17, 2013
(86) PCT No.: PCT/GB2013/000443

§ 371 Date: Apr. 16, 2015

(30) Foreign Application Priority Data
Oct. 17, 2012 (GB) 1218599.7

(51) Int. Cl. A01C 1/02; A01G 31/02; G05B 19/416; A01G 27/00

(52) U.S. Cl. CPC A01C 1/02; A01G 27/00; A01G 27/003; A01G 31/02; G05B 19/4166; G05B 2219/41303

(57) ABSTRACT

The present invention relates to a germination device for a plant seed comprising a plant seed receptacle (2) arranged to receive a plant seed. The device further comprises a hydrocel (4) comprising a water reservoir (10) and an air chamber (12). The hydrocel (4) is arranged to receive the plant seed receptacle (2). The device further comprises a seedbase (6) arranged to receive at least a portion of the hydrocel (4) and adapted to provide heat and/or water to the hydrocel (4). The device further comprises a biodome (8) arranged to engage the seedbase (6).

### FIELD OF THE INVENTION

The present invention relates to a germination device, a germination system, a plant growing device and a plant growing system which may be used for optimizing the growth conditions for plants (including plant seeds). Particularly, but not exclusively, the invention relates to a plant support chamber for use in an automated plant control system. The present invention also relates to a plant chamber (a HYDROCEL device) which is a feature of both a germination device and a germination and propagation device.

### BACKGROUND OF THE INVENTION

In many countries, home growing of plants for hobbies, supplementary income and for dietary purposes is on an increase. The scale of growing plants through arable farming, market gardening, community growing projects and intensive professional farming practices is also increasing at a rapid rate to try to alleviate shortages in world food production. The effects of climate change on weather patterns including severe flooding and drought together with issues concerning food security and rising population growth around the world are encouraging governments and consumers alike to take a greater interest in the source, quantity and reliability of food supplies.

The growth of plants and crops in smallholdings and gardens, where germination of seeds and propagation of plants is conventionally undertaken under glass (greenhouses) allows for the use of current plant technology using plant propagator equipment. These germination and propagation methods still rely on old unreliable plant husbandry and methodology, not easily expandable to meet greater demands and market fluctuations.

In agricultural farming and professional growing, the general system of spraying land using large volumes of water, using expensive pesticides and fungal treatments with little apparent concern for worldwide waste shortages and ensuing land contamination, will also increase as greater crop production yields are demanded.

Plants and crops are normally grown either in the outside environment soil substrates or in an inert, sterile growing medium in containers and in all cases fed a mixture of water and nutrients to assist growth.

The provision of bio-feeds and nutrients dissolved in water to form water solutions, can become very expensive through the natural waste that occurs when applying such solutions over large substrate areas or to many groups of containers particularly when spraying occurs.

The basic principle of growth in soil substrates whether in the outside environment or in containers is the same, where plants need to continuously develop their root mass to search for water, nutrients and air. This process in natural environmental growth is subject to many fluctuations particularly in areas prone to drought periods or the condition of the available growing areas.

So the majority of plants' available energy is used on the development of root systems to enable the plant to search for the life giving elements, thus restricting and reducing the quality of the upper plant growth. This is also true in current designs of propagators and germinators.

Alternative methods of plant and crop production must therefore be sought and used for the benefit of the whole of society worldwide.

There is therefore a need for a device or system which optimises the growth of plants/seeds while minimising water usage. The present invention has been designed to seek to address the problems and weaknesses in current plant growing processes and to provide in a planned and controlled way the necessary water, nutrients, air, heat, humidity and light in a human created local environment, which is more conducive to the nurturing of plants and crops and not subject to fluctuations of nature whether from natural weather systems or deficiencies in natural soil substrates.

### SUMMARY OF THE INVENTION

The present invention relates to (a) a germination device, (b) a germination system, (c) a plant growing device (d) a plant germination and propagation device and (e) an automated plant growing controller which may be used for optimising the growth conditions for plants, including growing plants from seeds. Particularly but not exclusively the invention relates to processes and benefits derived from the use of one or more of the following invention devices:
a. a germination device: this germination device is concerned with the germination of plant seeds. The germination device is also known as the CELPOD BIOCEL. Germination is the growth of an embryonic plant contained within a plant seed which following natural plant biological processes, results in a plant seedling. Germination is the biological process in which a plant emerges from a seed. Seed germination depends on both internal and external conditions. The most important external factors include temperature, water, oxygen and sometimes light or darkness. These growth factor requirements are provided by a germination device (the “CELPOD BIOCEL”) according to the present invention;
b. a germination system: the germination device may be received within a support structure or growbase The support structure may be arranged to provide water and heat to the germination device;
c. a plant growing device: this growing device is concerned with the growth to maturity of the plant seedling. Following germination of the plant seed contained within the germination device (the CELPOD BIOCEL), the germination device may be relocated/transplanted to the growing device (the CELPOD GROCEL). It is within the growing device that the process of watering and nutrient feeding takes place, to ensure the plant seedling matures to a healthy robust plant. The advantages of moving the whole germination device (the CELPOD BIOCEL) with enclosed plant seedling is the protection of the plant from damage through possible mishandling;
d. a plant germination and propagation device. (combined BIOCEL and GROCEL devices); and
e. An automated plant control system (the MICROGROWER device) may comprise one or more of the following:
   i. a programmable microcomputer plant biocontroller having one or more of RF signal, infra red and USB communication features;
   ii. a programming device in communication with the automated system. The programming device may comprise a control panel for manual input. The programmer may be hand held. The programmer may be used to create data “GROWCARDS” from blank “GROWCARDS”. The GROWCARDS may be pre-recorded data control cards. The data cards may be blank and the user may be able to be self program the cards with plant growing parameters using the handheld programmer. The programmer may be capable of infra-red and/or USB connection and/or Growcard communication with a MICROGROWER device.
   iii. Micro-sized irrigation water biopumps, water biovalves and water biomixers;
   iv. Main water mixing reservoir or growtank and storage tanks for nutrients and pH +/− adjusters; and
   v. A connected inline core, for example a single core for the supply of water/water solution or a twin core for the supply of water/water solution, power and/or data feed.

The benefits are high crop yields; healthy quality produce, water and nutrient saving processes; usually quicker growth and protection of the environment from human soil preparation contaminates. These devices may be hydroponic. The devices may be used in soil. These devices can covert non-plant growing locations into productive plant and crop growing locations whilst retaining their hydroponic functions.

The germination device (the CELPOD BIOCEL) may be used in multiple units to create a nursery germination system providing light, water nutrient solutions and heat. The germination device may be located in a support structure, such as for example a growbase. Multiple units of the germination device may form a growbed which may then be connected to a fully automated modular plant system (the MICROGROWER device) from which each germination device may receive under programmable control, water, heat, light and air quality control.

The germination device may be arranged to form the upper part of a plant germination and propagation device. The plant growing device may be arranged to form the lower part of a plant germination and propagation device (the CELPOD device).

The plant germination and propagation device (the CELPOD device) may be connected in multiples to other CELPOD devices to form a manual or fully automated modular plant growing system.

According to a first aspect, the present invention provides a germination device for a plant seed comprising:
a. a plant seed receptacle arranged to receive a plant seed;
b. a hydrocel comprising a water reservoir and air chamber arranged to receive the plant seed receptacle;
c. a seedbase arranged to receive at least a portion of the hydrocel and adapted to provide heat and/or water to the hydrocel; and
d. a biodome arranged to engage the seedbase.

The plant seed receptacle may be referred to as the BIOCEL SEED CAPSULE. The hydrocel may be referred to as the BIOCEL HYDROCEL. The hydrocel preferably provides a water reservoir and an air chamber for the nurturing of the plant seedling. The seedbase may be referred to as the BIOCEL SEEDBASE. The seedbase may be arranged to receive the lower portion of the hydrocel. The biodome may be referred to as the BIOCEL BIODOME. The biodome may be arranged to receive at least a portion of the hydrocel. The biodome may be arranged in use to receive the upper portion of the hydrocel.

The germination device is preferably a hydroponic unit. The hydrocel preferably comprises a hydrophilic reservoir. The water reservoir preferably comprises hydrophilic material. The hydrocel preferably comprises a hydrophobic air chamber.

The part of the plant that first emerges from the seed is the embryonic root. It allows the seedling to become anchored in the ground and start absorbing water. After the root absorbs water, an embryonic shoot emerges from the seed. The way the shoot emerges differs among plant groups. Seeds planted in the germination device of the invention (the CELPOD BIOCEL) act in a similar way to natural processes when planted in soil.

The plant seed receptacle (the SEED CAPSULE) is preferably located within the hydrocel of the germination device. The plant seed receptacle is preferably located within a hydrophilic reservoir of the hydrocel, for example within a recess in a hydrophilic reservoir of the hydrocel. The recess may be located in a central location of the hydrophilic reservoir of the hydrocel.

When water is introduced into the germination device (the BIOCEL), the plant seed receptacle reacts to the water, as it may be formed from dissolvable materials. These dissolvable materials contain root enhancers among others, which assist the germination process and are carefully selected biological stimulants, such as amino acids, the building blocks for the proteins and enzymes essential to the structure and metabolism of plant seedlings. In the germination device (the BIOCEL), the embryonic root invades the hydrophilic reservoir in the same way it seeks moisture and nutrients in the soil.

The germination device is designed so that the plant seed receptacle containing the seeds are able to germinate within the low moisture environment. The root system takes water and nutrients from the reservoir and other roots permeate into the surrounding hydrophobic air chamber.

Oxygen is required by the germinating seed for metabolism, Oxygen is used in aerobic respiration, the main source of seedling's energy until it grows leaves. Oxygen is an atmospheric gas that is found in soil pore spaces; if a seed is buried too deeply within the soil or the soil is waterlogged, the seed can be oxygen starved. The plant seedling is able to obtain a source of oxygen from the surrounding hydrophobic air chamber spaces in the germination device and the location of the air chamber overcomes oxygen starvation.

Temperature affects cellular metabolic and growth rates. Seeds from different species and even seeds from the same plant germinate over a wide range of temperatures. Seeds often have a temperature range within which they will germinate, and they will not do so above or below this range. To provide a balanced source of water supply, air temperature control, light and heat, the germination device (the BIOCEL) may be received within a support structure, such as for example a growbase to provide a germination system.

According to a further aspect of the invention there is provided a germination system comprising a germination device as herein described and a support structure arranged to receive the germination device and provide heat and/or water to the germination device.

The growbase may be shaped and dimensioned to receive at least one germination device and arranged to provide both water and heat to the germination device. The growbase may be arranged to supply water to the hydrocel water reservoir. The growbase preferably comprises a heat source, for example a PCB heater, to enable warm convected air to rise through the growbase into the germination device through the hydrophobic air chamber and then onwards into the biodome. The growbase may be attached in multiples to create a growbed. The germination system may therefore comprise a plurality of germination devices as herein described and a plurality of support structures arranged to receive a germination device and provide heat and/or water to the germination device. The support structures may be arranged such that each support structure is connected to or in communication with at least one other support structure. The growbed may be arranged to connect to an automated modular plant growing system, for example a MICROGROWER device.

When germination has completed, the germination device is removed from the growbed, complete with plant seedling and may be relocated or “transplanted” to a plant growing device for the lifetime of the plant.

According to a further aspect the present invention provides a plant growing device comprising:
a plant growth support structure (the “growtop”) arranged to receive a germination device; and
a water chamber structure (the “growtank”) arranged in communication with the plant growth support structure (“the growtop”), together with a lower structure being a water reservoir comprising a hydrophilic material arranged to hold water in suspension and an outer air core surrounding the hydrophilic material.

The outer air core may be provided by hydrophobic material.

The present invention provides a controlled but flexible plant growing device. The device can create a localised environment that gives each individual plant the resources it requires for sustainable growth. The device allows the grower gardener full flexibility to create unique plant growing solutions to satisfy most sustainable agricultural and horticultural demands with the knowledge that such solutions whilst providing healthy high plant growth yields, also protect the environment.

The present invention seeks to address plant growing inefficiencies and to help to provide a better growing environment for the germination, propagation and nurturing of plants. The present invention helps to achieve healthy plants with higher yields, from less space, using less water and nutrient solutions over a shorter period of time. The present invention seeks to benefit for example those living in locations which suffer from infertile drought ridden lands, such as the so called Third World and Development countries.

The plant growing device may enable a plant to be watered (or to be provided with mineral nutrient solution) individually at the location of growth. This may help to eradicate water/nutrient solution wastage, the device preferably provides a low volume reservoir at the plant location which is directly available to the plant.

The device helps to provide a plant with sufficient water and/or mineral nutrient solution to maintain a regular watering regime that helps to produce a healthy strong plant.

The water chamber structure is preferably in communication with the water reservoir of the lower structure. The lower water reservoir preferably comprises both hydrophilic material arranged to hold water in suspension and a hydrophobic material. Preferably, the hydrophobic material forms an outer air core surrounding the hydrophilic reservoir. Preferably the water chamber structure is located close to the location of growth of the plant so as to enable a plant to be watered at the location of growth.

In order to ensure a correct supply of water the germination device (the CELPOD BIOCEL) is preferably located in a plant growing device (a GROCEL). The plant growing device is preferably arranged to receive the germination device such that the hydrophilic reservoir of the germination device is located in communication with the lower hydrophilic reservoir of the reservoir structure of the plant growing device, The plant growing device is preferably arranged to receive the germination device such that when the plant growing device is watered by a plant growing system (GROSYSTEM) the water also rises into the reservoir of the germination device. This is achieved through a capillary action and ensures a gentle absorption of water by the germination device (BIOCEL) reservoir. Preferably the hydrophobic material is arranged to substantially surround or encompass the hydrophilic material. The reservoir may for example comprise a central core of hydrophilic material, in which the peripheral surfaces of the hydrophilic material are substantially encompassed by hydrophobic material.

The hydrophobic material for the reservoirs of the germination device or the plant growing device preferably comprises polyurethane foam of the type “polyether based Polyol”; density 20-24 kg/m³ and hardness 2.5-4.5 Kpa; cell structure 3400-5600 visiocell and textile strength 70 Kpa.

The hydrophilic material for the reservoirs of the germination device or the plant growing device preferably comprises PVA foam of the type “a polymer based on polyvinylalcohol”

The reservoir structure may be of any suitable shape, for example the reservoir structure may be substantially cylindrical in shape. The hydrophobic material is preferably arranged to provide an air chamber which may substantially surround or encompass the hydrophilic material. The hydrophilic material may form a central core with a surrounding layer of hydrophobic material. The hydrophobic material may form an annular portion around a central core. The central core may have any suitable shape, for example the central core of hydrophilic material may be substantially cylindrical in shape. In use, the plant growing device may be located in a substrate, such as soil (for example the plant growing device may be partially buried in the ground), and the hydrophobic material may provide a barrier between the substrate and the plant being grown.

The hydrophilic material and the hydrophobic material may be known as the HYDROCEL device.

The hydrophilic material preferably comprises an opening provided to receive at least a portion of the plant growth support structure. The plant growth support structure may comprise a substantially planar upper portion arranged to cover the reservoir and a lower portion which is adapted to extend into an opening provided by the reservoir.

The plant growth support structure and the reservoir structure, for example the water chamber, may include mutual engagement features for reciprocal engagement, such as for example resilient arms and recesses shaped and dimensioned to receive the resilient arms. The resilient arms and recesses may be spaced apart around the periphery of the plant growth support structure and the reservoir structure.

The plant growth support structure and/or the reservoir structure preferably define a chamber for receiving a plant. The plant growth support structure preferably provides an opening for receiving a plant/seed or a germination device. The opening may be provided in the upper portion of the plant growth support structure and is preferably aligned, in use, with a chamber provided by the reservoir structure.

The plant growing device may further comprise at least one water inlet in communication with the reservoir structure. The at least one inlet is preferably adapted to be connected to a water supply. The at least one water inlet may be arranged in use to extend in a horizontal plane. The at least one water inlet may be arranged to be in communication with the water chamber. The water chamber may provide at least one outlet arranged to provide a flow path from said at least one inlet to the lower reservoir. The outlet(s) may be in the lower surface of the water chamber. The outlet(s) may preferably be arranged so as to provide water/mineral nutrient solution directly into the portion of the reservoir comprising hydrophilic material. The water chamber may provide two outlet holes located opposite one another in the base of the water chamber. The advantages of using a water chamber to receive water from the inlet, rather than from one direct feed to the reservoir, provides a more balanced flow to the reservoir. This ensures a more even water spread across the top face of the reservoir and results in quicker absorption of the water/solution.

The plant growing device may further comprise at least one water outlet adapted to be connected where required to another plant growing device. The plant growing device may further comprise a further water inlet arranged in use to extend in a vertical direction in which the further water inlet is adapted to be connected to a water supply.

The water inlet(s) may be adapted to be connected to a nutrient water solution supply (or other solutions including soil sterilising and/or fertilising solutions, when located in soil). The water outlet may be adapted to be connected to another inline device for the purposes of creating an onward flow of the nutrient water solution.

The inlet(s)/outlet(s) may be arranged to enable localised replenishment of the reservoir thereby eliminating the need for flooding or spraying of the plant.

The plant growing device may comprise a manual valve which is designed to fit into the assembled plant growth support structure (the “growtop”) and the reservoir structure (the “growtank”) (forming for example the CELPOD GROCEL MK1.0) in order to control the water allowed to flow into the water chamber through the water inlet(s).

The plant growing device may comprise an automatic valve which is designed to fit into the assembled plant growth support structure (the “growtop”) and the reservoir structure (the “growtank”) (forming for example the CELPOD GROCEL MK2.0) in order to control the water allowed to flow into the water chamber through the water inlet(s).

The plant growing device is preferably but not exclusively suitable for use as a multiple inline plant growing system comprising a plurality of plant growing devices in communication capable of individually receiving and storing a set volume of water or water/solution from a common water flow source.

The plant growing device may be a hydroponic plant growing device, also capable of functioning as a hydroponic unit when located in soil. In a further use, should the device not be sited in soil, then the device may be located in a specific support structure, for example the MICROGROWER CELPOD GROBASE. A plant growing system may be provided comprising at least one plant growing device and a support structure or growing container (for example a growbase) adapted to receive the plant growing device. The support structure or growing container may include a heat source.

The plant growing device and/or the plant germination and propagation device is preferably but not exclusively suitable for use with an automated plant control system, for example the MICROGROWER device. The automated system provides full control over the germination device and/or the plant growing device. The automated plant control system may comprise a programmable microcomputer acting as a plant growing biocontroller for the control and communication to connected units. The automated system may provide water storage and nutrient mixing preparation facilities. The automated system may be connected to multiple plant germination and propagation devices (CELPOD devices).

The automated plant control system may comprise multiple moulded parts that when assembled provide a container in which resides specific components that together form the device.

The automated plant control system may comprise one or more of the following:
a. a programmable microcomputer plant biocontroller having one or more of RF signal, infra red and USB communication features;
b. a programming device in communication with the automated system. The programming device may comprise a control panel for manual input. The programmer may be hand held. The programmer may be used to create data “GROWCARDS” from blank “GROWCARDS”. The GROWCARDS may be pre-recorded data control cards. The data cards may be blank and the user may be able to be self program the cards with plant growing parameters using the handheld programmer. The programmer may be capable of infra-red and/or USB connection and/or Growcard communication with a MICROGROWER device;
c. Micro-sized irrigation water biopumps, water biovalves and water biomixers;
d. Main water mixing reservoir or growtank and storage tanks for nutrients and pH +/− adjusters; and
e. A connected inline core, for example a single core for the supply of water/water solution or a twin core for the supply of water/water solution, power and/or data feed.

The biocontroller may be a microcomputer to provide software and hardware programming features for the purpose of setting up control and operation features of connected system modules. These modules may be Celpod Growbeds, inline core connected Celpod devices either manual or automatic valve operated or surface mounted Celpod Grobases containing Celpod devices.

The programmer may have the following features:
a. hand held thus mobile can be used indoors and outdoors;
b. capable of infra-red and/or USB connection and/or Growcard communication with a MICROGROWER device;
c. A card slot may be fitted for example at the front base arranged to receive a data growcard for downloading to the programmer for transfer to a MICROGROWER device. Alternatively a blank growcard may be inserted into the card slot and the simple keyboard may be used to create a new data growcard. This Growcard may then be used in the same way as an ordinary growcard.

Such controls provide plant growing parameters in the form of software variables which when downloaded from the programming features activate and extend existing main programme features of the biocontroller.

The automated system may receive a communication for a RF signal by a moisture sensor in response to a minimum water level reading. The automated system may respond by activating the watering process. This response may start a biopump located in the automated system which may raise the low water pressure in the specific connected Core, to which the plant germination and propagation device is attached. This raise in water core pressure results in water entering the series of plant germination and propagation devices attached to the specific core. The moisture sensor device issuing the RF signal may be part of the line series of plant germination and propagation devices.

The automated system may be connected to a line of plant germination and propagation devices using an autovalve system. The watering process may be controlled by a line core pressure sensor and not by individual moisture sensors. The pressure sensor may be connected to the automated system by a physical data cable as part of, for example, a twin core. The other core being the water supply. When the constant low pressure water volume in the core is reduced following the opening of the water valves the pressure sensor may respond by activating the biocontroller in the automated system. This response turns on the biopump which pumps additional water/water solution into the core. The system may repeat itself.

For non-hydroponic growing, irrigation is required when rainfall is insufficient to grow plants. The automated system provides water and/or nutrients for the purposes of irrigation to the germination device and/or plant growing system.

The automated device may comprise a mixing tank which incorporates an automatic maximum-minimum water level sensor and connected to a water input biovalve, which may be a solenoid valve. The biovalve may be connected to an external water source (for example mains water or a water storage container).

By means of the installed biocontroller, pre-set operational software programme are activated. Such programmes may be pre-recorded data programmes specifically created for use by the automated system or as self created programmes, using programmable facilities and templates supplied with the automated system. These programmes may allow the device to create individual pH+/− adjusted nutrient solutions specific for the intended plant growing processes.

The automated device may receive a RF signal from a moisture sensor in response to a minimum water level reading taken from the plant growing device reservoir structure. The automated device may activate the watering process. For example, the automated device may activate the biopump in the specific connected core, the result of which allows the water to overcome water surface tension at the valve entry point and enter the growtank and then the reservoir structure. The water may therefore enter the plant growing device or series of plant growing devices.

The automated device may be connected to a line core of plant growing devices using an autovalve system. The watering process may be controlled by a line core pressure sensor and not by individual moisture sensors. The pressure sensor may be connected to the automated device by a data cable as part of a twin core (the other core being the water supply). When the low pressure water volume in the core is reduced following the opening of the automatic water valves the pressure sensor may respond by activating the biocontroller. The biocontroller may activate the biopump to pump additional water/water solution into the water core.

In practice whilst the plant growing device (the CELPOD GROCEL MK1.0 device) can be used without the presence of a germination device (the CELPOD BIOCEL support device), it is preferable for the plant to have been germinated within the latter and then relocated into the plant growing device (the CELPOD GROCEL MK1.0 device) for the continued nurturing of the plant seedling. The plant growing device (the GROCEL device) may further comprise a cover or dome (which may typically be transparent) and which may be arranged to engage the upper portion of the plant growth support structure (the “growtop”), in order to provide temperature, frost and/or humidity protection. The cover/dome may be of any suitable shape. The cover/dome may be arranged to abut or removably engage a portion of the plant growth support structure. For example, the cover/dome and the plant growth support structure may comprise mutual engagement features for resilient engagement. Mutual engagement features may include at least one resilient catch or opposing catches for engaging corresponding recesses.

The water chamber may define at least one opening into the lower reservoir. As such, in use, the roots of the plant may extend from the water chamber into the reservoir (and may as a result form an encapsulating root ball). The plant growth support structure may comprise a fastener for engaging (for example resiliently engaging) the reservoir. The fastener may comprise a plurality of resilient arms arranged to engage the periphery of the reservoir.

The same principle exists when a germination device (a CELPOD BIOCEL) is relocated to the plant growing device (a CELPOD GROCEL) since the plant seedling formed after germination within the germination device may extend its roots from the chamber within the germination device (BIOCEL) into the reservoir, for example into the lower water reservoir of the plant growing device (GROCEL).

The plant growing device may further comprise a moisture sensor, for example a moisture sensor that reads the maximum and minimum water levels contained in the hydrophilic reservoir. The moisture sensor may be located and adapted to identify and control the supply of water from the inlet to address the watering needs of the plant, access being through a Manual Water Valve. The moisture sensor may further be located and adapted to identify and control the supply of water from the inlet by activating an automatic water valve which forms part of the device in order to address the watering needs of the plant.

The moisture sensor may be adapted to be in communication with a controller (MICROGROWER device) for the receiving of programmable watering parameters. The moisture sensor may be in communication with a controller (MICROGROWER device) for activating the watering system. The sensor may for example communicate with the controller using radiofrequency (RF) signals. The sensor may for example communicate with the controller using control data received by direct cable connection. The data cable using one core of an external twin core where the other core is used for water/nutrient supply.

The system (the MICROGROWER CELPOD GROSYSTEM) requires the CELPOD moisture sensor to be “registered” with the controller in order to establish a unique radio frequency.

These parameters may also provide control data used for an automatic water valve to determine the water opening orifice size of the valve which results in an adjustable flow of water from the inlet into the reservoir structure.

The moisture sensor may be arranged to emit a radiofrequency signal when the moisture level within the reservoir reaches a minimum level and/or when the moisture level within the reservoir reaches a maximum level. The minimum/maximum levels may be predetermined and may be programmed into the controller.

The manual water valve located in a CELPOD MK1.0 device features a fixed and small entry hole at the point of connection to a connected water inline core. Due to the entry size, water surface tension prevents the low water pressure in the core from accessing through the manual valve into the growtank and then to the reservoir. Raising the low water pressure in the inline core, overcomes the water surface tension. Dropping the water pressure in the inline core, returns the system to the previous position (stopping the Biopump). By further means the orifice size in the manual water valve can be manually adjusted by use of a fitted valve control to allow different levels of water flow through the manual valve.

The automatic water valve may be connected to an external water source core which is constantly kept at low pressure. The automatic valve may be connected to a continuously primed water solution core, which is the water source for the device. When water is taken from the core, the drop in water volume is registered by a pressure sensor which activates a system controller Biopump to replenish the water core volume. The device acts independently of other devices in the same growing system at all times.

Activation of the moisture sensor causes the automatic valve to open to the core and the incoming water replenishes the reservoir. In an automated system, there may be no need for any form of RF signal sensor. Preferably, the automated system does not include an RF signal sensor. The automated system relies entirely on the moisture sensor situated within the plant germination and propagation device (the CELPOD) activating the automatic water valve, when a minimum water level is detected in the hydrocel reservoir. The opening of the automatic valve allows water to enter from the line core into the plant growing device (the GROCEL) and replenish the hydrocel reservoir.

The core system to which the plant germination and propagation device (the CELPOD device). is attached may be always primed with water nutrient solution and automatically replenishes itself when the core pressure drops, following individual plant growing devices taking water solution from the system. The loss of water solution in the core may replaced through a low pressure sensor in the system being activated which releases additional water volume into the core.

Mature seeds are often extremely dry and need to take in significant amounts of water, relative to the dry weight of the seed, before cellular metabolism and growth can resume. Most seeds need enough water to moisten the seeds but not enough to soak them. It is for this reason that in the plant growing device of the invention the seeds are located in a germination device rather than directly into a reservoir of a plant growing device. A further reason is the reservoir structure of the plant growing device (the GROCEL) may be controlled by a moisture sensor, which ensures a regular supply of water whereas there is no moisture sensor sited in the germination device (BIOCEL).

According to another aspect of the invention, there is provided a plant germination and propagation device (the CELPOD device) comprising a at least one plant growing device according to embodiments of the invention and at least one germination device according to embodiments of the invention received with the at least one plant growing device. Preferably the plant germination and propagation device comprises a plurality of plant growing devices and germination devices. The plant growing devices and germination devices may be arranged in an array comprising for example rows of aligned plant growing devices.

The plant growing devices (in the form of for example CELPOD MK1.0 or CELPOD MK2.0) may be connected to each other by means of a low pressure primed water filled core. The devices may be connected such that each device is in communication with at least one other plant growing device. When the plant growing devices are laid out in an array the manual valve control of each device may be adjusted (CELPOD MK1.0). This adjustment ensures a balanced delivery of water/nutrient solution from the low pressure primed core through the valve and into the reservoir structure (“the growtank”) of the device, following system response to a low level moisture reading in the devices reservoir. Alternatively, when the plant growing devices are laid out in an array the automatic valve of each device controls the water supply into each independent plant growing device reservoir structure (“growtank”).

The plant germination and propagation device may further comprise a controller. In this instance the controller may be for example, the MICROGROWER device. The controller may be arranged to control the supply of water (or nutrient solution) to the plurality of plant growing devices. The controller may be connected by means of a multiple core which provides both water/nutrient solution and data connection to the plurality of plant growing devices. The controller may be fitted with RF Signal electronic sensor receivers for this purpose. At least one of the plurality of plant growing devices may be provided with a sensor, for example a moisture sensor in communication with the controller.

The sensor may be a RF moisture sensor, such as for example a moisture sensor sited within the reservoir structure (the “growtank”) of the plant growing device (for example the CELPOD GROCEL). Each section, for example row, of the devices may be provided with a single sensor device. The device sensor may be adapted and located in communication with a single device in a particular section or row. For example, one device may be provided with a sensor for each ten devices. Each section, for example row, of the devices may provide each single device with its own moisture sensor for independent use and control over water supplies and data input. The moisture sensor may activator the automatic water valve when further water supplies are required to replenish the depleted plant growing device reservoir.

The devices may be arranged in arrays such that multiple rows could be connected to an automated system which provides individual growth programs such that each row/section is water individually with different nutrient solutions.

The controller may on receiving an RF signal from the sensor activate a Biopump which is located in the controller and also connected to the low pressure water core. The Biopump is required to increase the water pressure in the connected supply core. The resultant increase is then sufficient to force entry into the devices reservoir structure (the “growtank”) through the present manual control valve and supply a similar quantity of water (or nutrient solution) to each of the ten devices.

Alternatively, each device in the row may be fitted with a moisture sensor. The controller on receiving multiple RF signals may calculate an average reading from the sensors then by comparing this reading with a set parameter for the row, responds according to requirements. The devices may be arranged in arrays such that multiple rows could be connected to an automated system which provides individual growth programs such that each row/section is watered individually with different nutrient solutions. It will be appreciated that any references herein to plants are also intended to encompass seeds and growing may encompass all stages of plant growth including for example germination and propagation.

### BRIEF DESCRIPTION OF THE DRAWINGS

Embodiments of the invention will now be described with reference to the accompanying drawings, in which:

FIG. 1A is a schematic side view of one embodiment of the germination device (the BIOCEL);

FIG. 1B is an exploded view of the germination device (the BIOCEL) of FIG. 1A;

FIG. 2A is an exploded view of the water reservoir of one embodiment of the germination device;

FIG. 2B is a cross-sectional view of the water reservoir of FIG. 2A

FIG. 3 is a schematic view of one embodiment of the plant growing device (the CELPOD GROCEL MK1.0) together with the germination device (the BIOCEL);

FIG. 4 is a schematic view of the reservoir and air chamber of the plant growing device (the GROCEL);

FIG. 5 is a schematic exploded view of one embodiment of the plant growth support structure and reservoir of the plant growing device with a manually adjustable valve;

FIG. 6 is a schematic exploded view of a further embodiment of the plant growth support structure and reservoir of the plant growing device with an automatic valve;

FIGS. 7A and 7B are a schematic views of a support structure or growbase according to embodiments of the invention;

FIG. 8 is a schematic view of germination devices according to one embodiment of the invention attached to a growbase connected in multiples to form a growbed;

FIG. 9 is a schematic view of an automated watering system (MICROGROWER device) according to an embodiment of the invention

### DETAILED DESCRIPTION OF EMBODIMENT

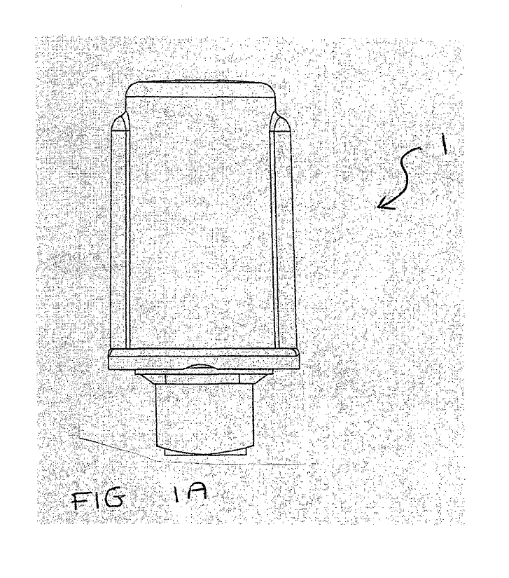

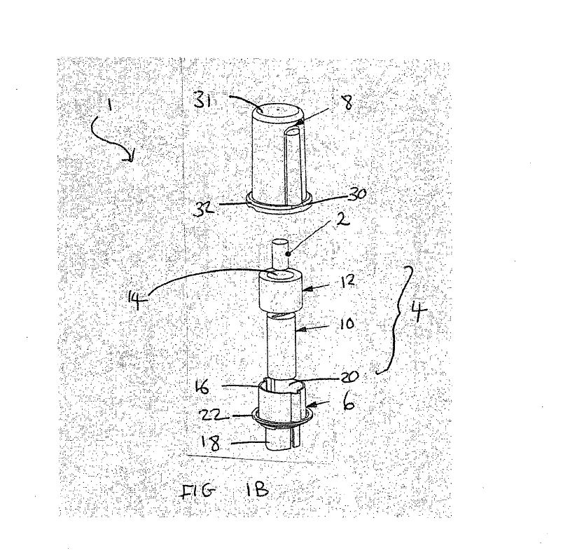

As shown in FIGS. 1A and 1B, the germination device 1 comprises a plant seed receptacle 2; a hydrocel 4, a seedbase 6 and a biodome 8. The seed receptacle 2 comprises an opening for receiving and supporting a plant seed (not shown). The seed receptacle 2 is formed from dissolvable materials. These dissolvable materials contain root enhancers among others, which assist the germination process and are carefully selected biological stimulants, such as amino acids, the building blocks for the proteins and enzymes essential to the structure and metabolism of plant seedlings.

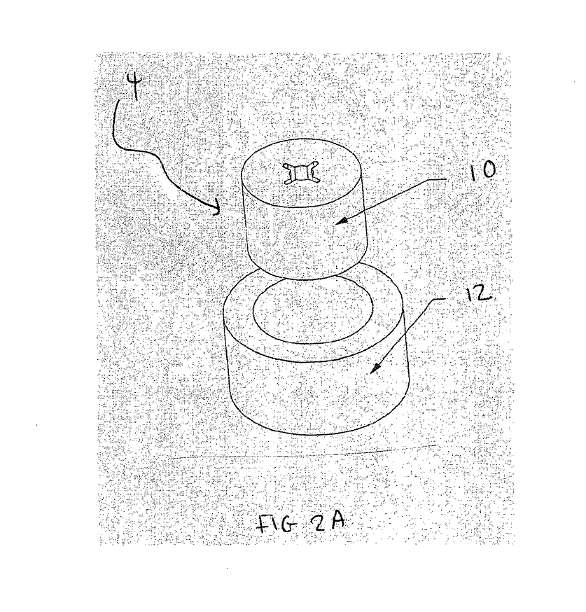

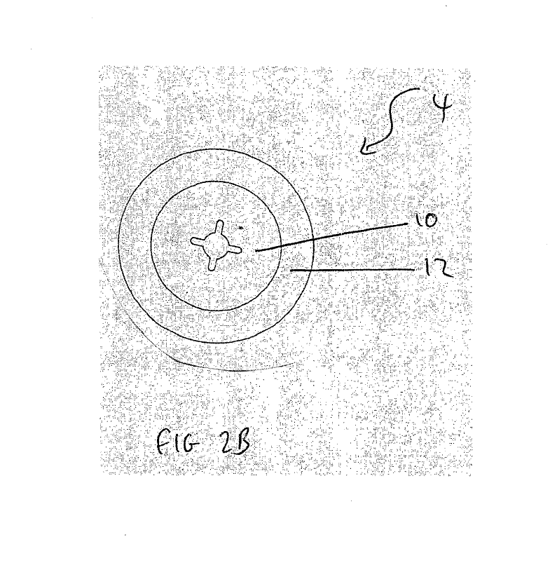

The hydrocel 4 comprises a hydrophilic water reservoir 10 and an air chamber 12. The air chamber 12 is composed of hydrophobic material. As shown in FIG. 2, the hydrophilic water reservoir 10 is substantially cylindrical in shape and is dimensioned to be received within an opening 14 provided by the hydrocel air chamber 12. The air chamber 12 is shaped and dimensioned to encompass the reservoir 10. The air chamber 12 forms an annular portion around the central core of hydrophilic water reservoir 10.

Seed base 6 is predominantly cylindrical in shape having a first proximal end 16 for receiving the hydrocel 4 and a second distal end 18 for engaging a plant growing device or support structure (not shown). The first proximal end 16 of the base 6 provides an opening 20 extending into a channel dimensioned and shaped to receive and support the hydrocel 4. The seed base 6 has a protruding engagement surface 22 extending circumferentially around the outer surface of the base 6. The engagement surface 22 is located towards the second distal end 18 of the base 6.

Biodome 8 is substantially cylindrical in shape having a first proximal end 30 providing an opening shaped and dimensioned to receive the hydrocel 4 and the seed receptacle 2. The biodome 8 has a second closed distal end 31. The biodome 8 has an engagement surface 32 at the first proximal end 30 for abutting and engaging the engagement surface 22 of the seed base 6.

In use, the hydrophilic water reservoir 10 is placed within the channel of the air chamber 12 to form the hydrocel 4. The hydrocel 4 is placed through the opening 20 into the channel of the seed base 6. The plant seed is placed within the seed receptacle 2. The seed receptacle 2 is placed on the upper surface of the hydrocel 4. The biodome 8 then surrounds the seed receptacle 2 and the hydrocel 4 such that the engagement surface 32 of the biodome 8 and the engagement surface 22 of the seed base 6 are placed in contact with each other.

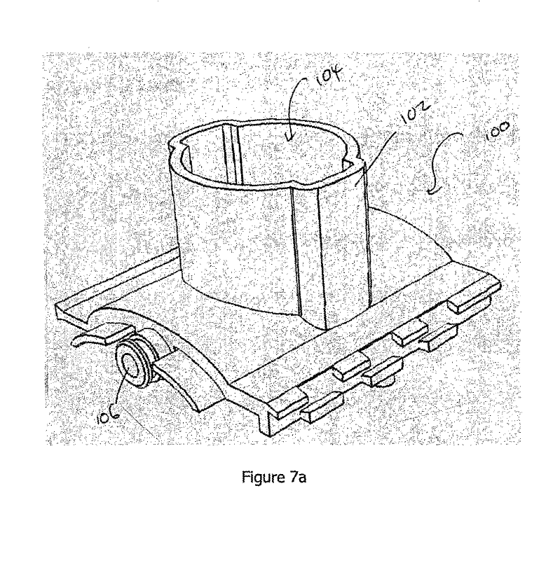

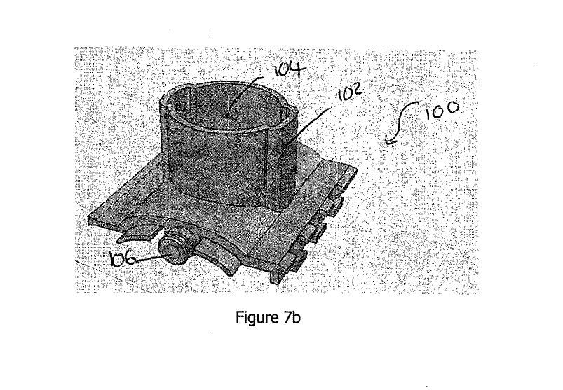

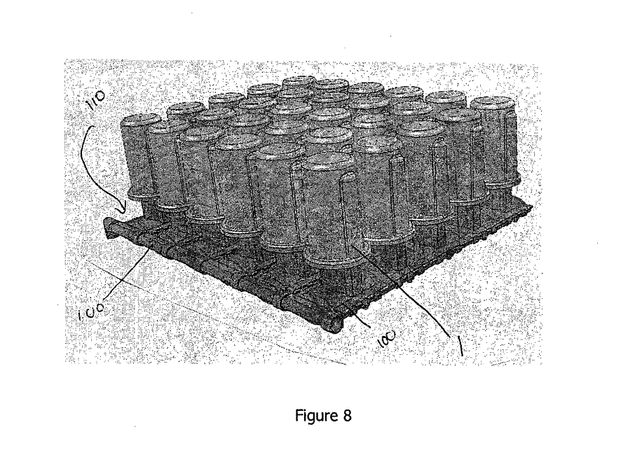

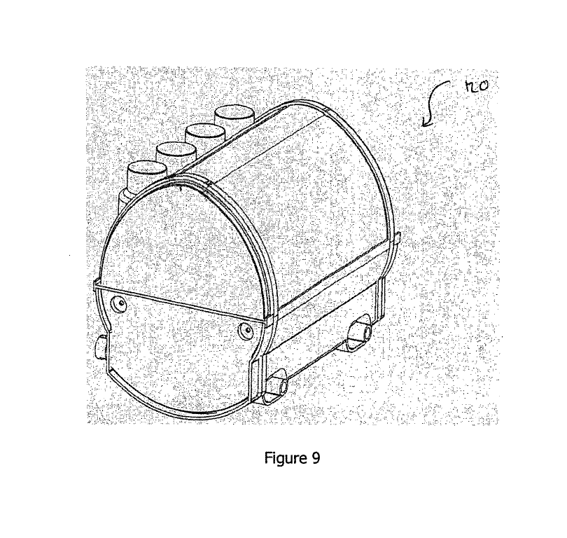

With reference to FIGS. 7A, 7B and 8, the germination device 1 may be placed in a support structure or growbase 100 (MICROGROWER CELPOD GROWBASE) to provide germination system providing a balanced source of water supply, air temperature control, light and heat. The growbase 100 comprises an upstanding portion 102 providing an opening 104 arranged to receive the second distal end 18 of the germination device 1. The growbase 100 is adapted to receive a germination device 1 and to provide heat and water to the germination device 1. The growbase 100 comprises a water inlet 106 arranged to be connected to an external water source (not shown). The growbase 100 enables water to enter the germination device 1 reservoir 10. The growbase 100 comprises a PCB heater (not shown) which allows convected air to rise through the growbase 100 into the germination device 1 through the air chamber 12. The growbase 100 is attached in multiples to create a growbed 110. Each support structure or growbase 100 is connected to at least one other support structure 100 to form an array. As shown in FIG. 8, the germination system is arranged to comprise a 5×6 array of germination devices 1 and support structures 100 in communication. The growbed 110 is connected through an endcap manifold to an automated modular plant growing system 120, for example to a MICROGROWER device as shown in FIG. 9.

The automated system 120 comprises a programmable microcomputer acting as a plant growing biocontroller for the control and communication to connected units. The automated system provides water storage and nutrient mixing preparation facilities. When germination has been completed the germination device 1 is removed from the growbed 110 and relocated to a plant growing device.

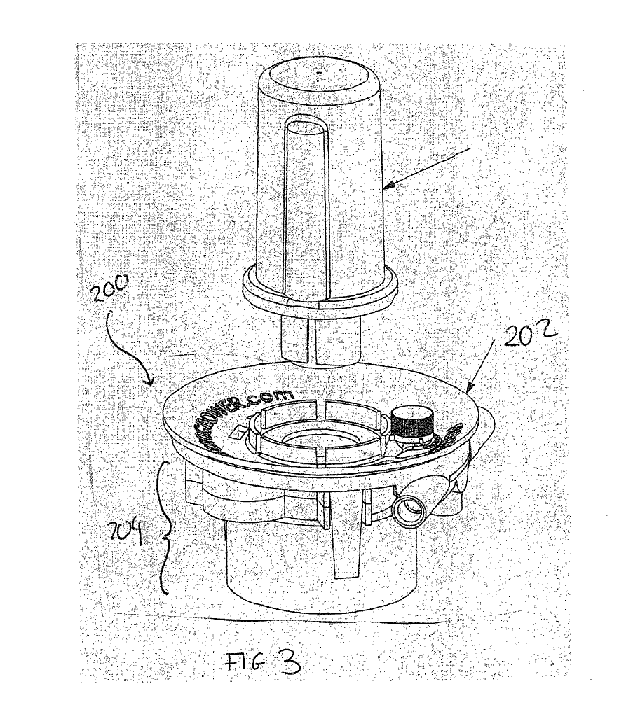

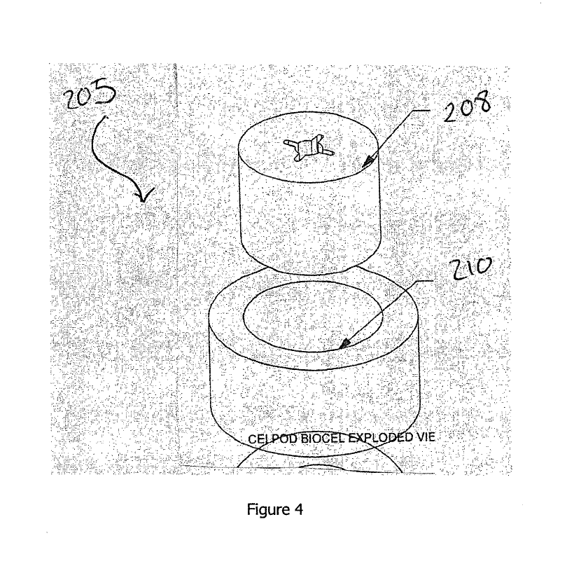

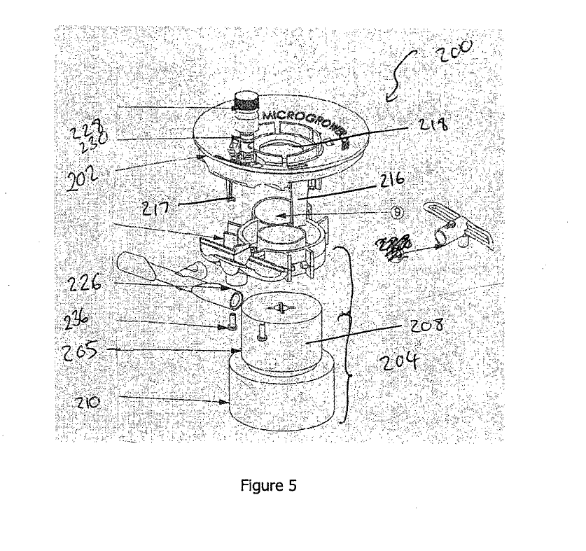

As shown in FIG. 3 the plant growing device 200 comprises three separate components: a plant growth support structure 202, a reservoir structure 204 and a cover 206. The plant growth support structure 202 is provided by the upper portion of the device 200. The reservoir structure 204 is provided by the lower portion of the device 200. As shown in FIG. 5, the reservoir structure 204 comprises a lower reservoir 205 comprising a central core of hydrophilic material 208 to hold the water/mineral nutrient solution in suspension.

The peripheral surfaces of the central core of hydrophilic material 208 are substantially encompassed by hydrophobic material 210. The lower reservoir 205 is substantially cylindrical with the hydrophobic material 210 forming an annular portion around the cylindrical core of hydrophilic material 208. The hydrophobic material 210 typically also covers the lower surface of the reservoir 204.

The cover 206 is a transparent dome arranged to removably engage the plant growth support structure 202. A resilient catch 207 (and typically a pair of opposing catches) is provided on the cover 206 for engaging at least one co-operatively shaped recess provided by the plant growth support structure 222.

The plant growth support structure 202 has a substantially circular cross-section which is arranged to cover the reservoir structure 204. The plant growth support structure 202 comprises three spaced apart resilient arms 216 extending substantially perpendicular to the plane of the plant growth support structure 202. Each resilient arm is provided with prongs 217 extending axially inward at both their distal ends and at an intermediate point between the plane of the plant growth support structure 202 and the distal end. The plant growth support structure 202 provides a central circular opening 218.

The reservoir structure 204 defines a chamber for receiving a germination device 1. The upper extent of the chamber is aligned so as to be connected to the corresponding opening 218 provided by the plant growth support structure 202. The reservoir structure 204 comprises a water chamber (a growtank) 220 and a lower water reservoir 205 in communication with the water chamber 220.

The plant growth support structure 202 further comprises a water/mineral nutrient solution inlet 226 adapted to be connected to a water or mineral nutrient supply (not shown). In order to enable several plant growing devices to be connected in series the inlet 226 may be an inline inlet (i.e. it provides a conduit through which water may also flow to a subsequently connected device). The inlet 226 runs substantially tangentially to the plant growth support structure 202. The inlet 226 is provided with a valve 228. The inlet 226 forms a T-junction with the valve 228.

FIG. 5 also provides for a vertical water entry by means of inlet 226a and follows the same location fitting as 226 with valve 228

The reservoir structure 204 provides outlets which are in communication with the reservoir (not shown). The outlets are arranged so as to provide water/mineral nutrient solution directly into the portion of the reservoir 205 comprising hydrophilic material (not shown).

A substrate moisture sensor 230 is placed in communication with reservoir structure 204. The sensor 230 is arranged to communicate with a controller (not shown) using radiofrequency signals when the moisture level within the reservoir 204 has reached a minimum predetermined level and a maximum predetermined level. The substrate moisture sensor 230 is located and adapted to identify and control the supply of water from the inlet 226 to address the watering needs of the plant.

In the embodiment shown in FIG. 5, the valve 228 comprises a valve body 230 which is vertically inserted into the valve 226 and which acts as a simple ball valve whereby the valve body 230 features a hole which when aligned with the inlet entry of valve 226 allows water to flow through the valve. No springs or valve inserts are required. The valve 226 or 226a are secured in place by a pair of thermostatic fixing screws 236. The valve 228 can be manually adjusted to suit the Celpod location.

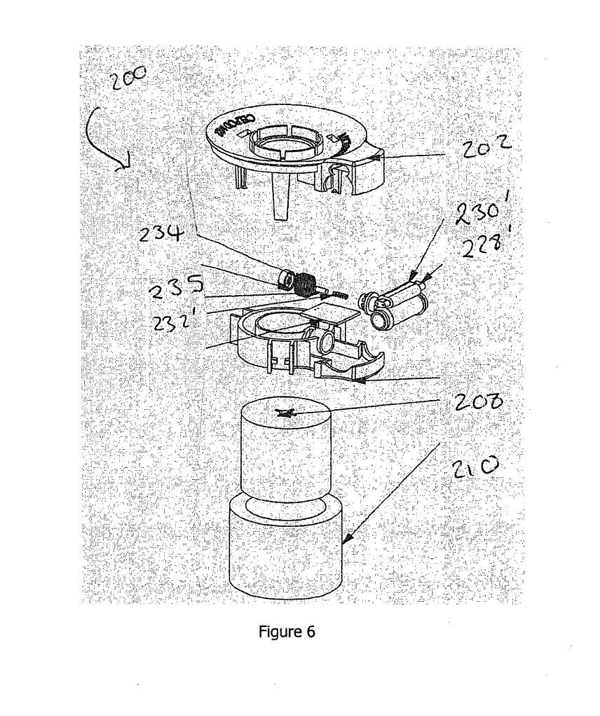

In the embodiment shown in FIG. 6, the valve 228 comprises a valve body 230 resiliently biased by a spring 232. The plant growth support structure 202 further includes a solenoid coil 234 and pin 235 arranged to be in communication with a controller (not shown) for adjusting the spring and therefore operate the valve 228 as required.

In use, the plant growth support structure 202 and the water chamber 220 are resiliently engaged via the intermediate prongs 217 of the resilient arms 216 which engage the complimentary recesses 221. A germination device 1 is placed through the opening 218 of the plant growth support structure 202 and through chamber of the reservoir structure 204. The cover 206 is engaged with the upper surface of the plant growth support structure 202.

The substrate moisture sensor (not shown) sends a radiofrequency signal to the controller as the moisture within the reservoir 204 is below the minimum predetermined level. As a result, the controller (not shown) arranges for water (which may be provided with mineral nutrient solution) to be introduced to the plant growth support structure 202 through the inlet 226. The valve 228 opens either automatically or manually. Water flows through the inlet 226 via the valve 128 and into the water chamber of the reservoir 204. The water then flows through the outlets provided by the water chamber of the reservoir 204 directly into the portion of the reservoir comprising hydrophilic material 208. The plant grows to form an encapsulating root ball within the reservoir 204.

When the substrate moisture sensor (not shown) detects that the moisture within the reservoir 204 has reached a predetermined maximum value, the sensor sends another radiofrequency to the controller which causes the controller to stop the water supply to the plant growth support structure 202. The valve 228 returns to its closed position and no more water enters the plant growth support structure 202.

As the plant grows, moisture within the reservoir 204 decreases. When the sensor detects that the moisture within the reservoir 204 has reached a predetermined minimum level another radiofrequency signal is sent by the sensor to the controller. The controller then activates the water supply and the process starts all over again as required.

In the event that an automated valve is used, the moisture sensor acts in the same way as for a manual water valve, excepting when either a low water level reading or high water level reading is taken, it causes the automatic valve to either open or close in accordance to the sensor reading.

Although the invention has been described above with reference to one or more preferred embodiments, it will be appreciated that various changes and/or modifications may be made without departing from the scope of the invention as defined in the appended claims.

A further adaptation of the device, the BIOCEL SEED CAPSULE can be a biodegradable capsule, similar to a human drugs capsule, which is filled with either a dry or gel format germination enhancer, together with the selected seeds.

Also, the capsule can be located within the HYDROCEL and when water or any other suitable fluid is introduced, the capsule body collapses, releasing the germination enhancer for abortion by the fluid and freeing the seeds for germination and propagation.

Still further, in another adaptation of the plant growing device, by using a different physical design, yet maintaining the same working principle and concept as other similar devices.

A still further adaptation of the device is formed as a very simple design allowing lower manufacturing costs with additional benefits.

As has been described herein it will be appreciated to form a solid or hollow embodiment, the hollow legs can be used to allow sterilising water solution to be pumped into surrounding soil, when the CELPOD is located in a soil substrate (the CELPOD uses the soil for location and sitting purposes only) to destroy harmful pathogens and similar soil diseases or for the purposes of providing ancillary nutrients into the immediate CELPOD soil environment as a soil preparation. It is possible to use hollow legs in multiples

It is possible in a further embodiment for the device to use BLUETOOTH or similar wireless technology.

Still further, in a further adaptation of the plant growing system, the MICROGROWER device, the system is built with an alternative MIXING TANK design that utilises mains water pressure to provide a mixing power source. Preset volume of Nutrients are introduced to the system Mixing Tank.

The system Mains Water Inlet Latching Valve, when activated, opens to allow the mixing tank to fill with mains water to maximum depth.

Whilst the mixing tank is being filled, the incoming water pressure through turbulence, mixes the water and nutrients to form a solution.

When the tank maximum capacity is reached, determined by a tank water level sensor, a further outlet latching valve is activated and this allows the continued water pressure to force the mixing tank volume of water solution, to enter the flow line core system and eventually to the connected CELPODS.

Thus in an inexpensive way, effectively replacing flow line water Biopumps and Mixing Impellers.

The mains water pressure is then used as a powered delivery system through the line cores, which allows for a bigger CELPOD growing system.

In a further adaptation of the plant growing system, the MICROGROWER device, the system is modified to include CELPOD BIOVALVES which are located at strategic locations in the system.

The CELPOD BIOVALVE is a latching valve located in a suitable container design that includes in the first instance, an electronic controller and is connected to a mains line water core.

When the CELPOD SENSOR device, emits a RF signal to the Microgrower Biocontroller device receiver, the signal is also received by the CELPOD BIOVALVE. The signal received by the CELPOD BIOVALVE, activates the BIOVALVE electronic controller and opens to allow water solution to pass from the main line core into secondary line cores. When a second RF signal is emitted by the CELPOD SENSOR, the BIOVALVE closes and cuts off the line core water supply.

In this way, a secondary CELPOD system attached to the main water line core, can be water replenished as an independent system.

In a second adaptation, the CELPOD BIOVALVE operates through detecting differences in main core water pressures.

The BIOVALVE is built to include a water pressure detector. When additional water (mains water pressure) is introduced to a LOW water pressure main line core, the line core water pressure increases and forms a HIGH pressure system. This change in water pressure is detected by the BIOVALVE and opens to allow water to enter a secondary CELPOD growing system. When the water pressure decreases the BIOVALVE closes.

This system provides an alternative way to providing water to secondary CELPOD growing systems which are attached to the main line core, controlled by the Microgrower device.

1. A germination device for a plant seed comprising:
a. a plant seed receptacle arranged to receive a plant seed;
b. a hydrocel comprising a water reservoir and an air chamber, and in which the hydrocel is arranged to receive the plant seed receptacle;
c. a seedbase arranged to receive at least a portion of the hydrocel and adapted to provide heat and/or water to the hydrocel; and
d. a biodome arranged to engage the seedbase.

2. A device as claimed in claim 1, in which the water reservoir comprises hydrophilic material.

3. A device as claimed in claim 1, in which the hydrophilic material comprises PVA foam.

4. A device as claimed in any preceding claim, in which the air chamber comprises a hydrophobic material.

5. A device as claimed in claim 4 in which the hydrophobic material comprises polyurethane foam.

6. A device as claimed in claim 5 in which the polyurethane foam has is polyether based Polyol having a density 20-24 kg/m³ and hardness 2.5-4.5 Kpa; cell structure 3400-5600 visiocell and textile strength 70 Kpa.

7. A device as claimed in any one of claims 2 to 6 in which the air chamber is formed from hydrophobic material arranged to substantially encompass a water reservoir comprising hydrophilic material.

8. A device as claimed in any preceding claim, in which the hydrocel provides a recess arranged to receive a plant seed.

9. A device as claimed in claim 8, in which the recess is located in a central location of the hydrocel.

10. A germination system comprising at least one germination device as claimed in any one of claims 1 to 9, and a support structure arranged to receive the at least one germination device, in which the support structure is arranged to provide heat and/or water to the at least one germination device.

11. A plant growing device comprising:
a plant growth support structure arranged to receive a germination device; and
a reservoir structure arranged in communication with the plant growth support structure,
in which the reservoir structure comprises a water reservoir comprising a hydrophilic material arranged to hold water in suspension and an air chamber comprising hydrophobic material substantially surrounding the hydrophilic material.

12. A device as claimed in claim 11, in which the hydrophilic material comprises PVA foam.

13. A device as claimed in either of claims 11 and 12, in which the hydrophobic material comprises polyurethane foam.

14. A device as claimed in any one of claims 11 to 13, in which the reservoir structure comprises a water chamber and a lower water reservoir in communication with the water chamber.

15. A device as claimed in claim 14, in which the plant growth support structure is arranged to receive a germination device such that the water reservoir of the germination device is located in communication with the lower water reservoir of the plant growing device.

16. A device as claimed in any one of claims 11 to 15 in which the device further comprises at least one water inlet in communication with the reservoir structure, in which the at least one inlet is adapted to be connected to a water supply.

17. A device as claimed in claim 16, in which said at least one water inlet further comprises a valve for controlling the flow of water from a water supply into the reservoir structure.

18. A device as claimed in claim 17, in which the valve comprises a manual valve or an automated valve.

19. A device as claimed in any one of claims 11 to 18 in which the device further comprises a moisture sensor.

20. A device as claimed in claim 19, in which the device further comprises a controller and in which the moisture sensor is adapted to be in communication with the controller.

21. A device as claimed in claim 20, in which the moisture sensor is adapted to communicate with a controller by radiofrequency (RF) signals.

22. A device as claimed in claim 18 in which the valve is an automated valve, and in which the moisture sensor activates the valve operable between an open position when the moisture sensor detects a low water reading and a closed position when the moisture sensor detects a high water reading.

23. A device as claimed in any of claims 11 to 21, in which the device further comprises a heat source.

24. A plant germination and propagation device comprising:
a. at least one germination device as claimed in any one of claims 1 to 10; and
b. at least one plant growing device as claimed in any one of claims 11 to 22,
in which the at least one germination device is received within the at least one plant growing device.

25. An automated plant control system for use with any device as claimed in any one of claims 1 to 24, in which the system comprises one or more of the following:
a. a programmable microcomputer plant biocontroller having one or more of RF signal, infra red and USB communication features;
b. a programming device in communication with the automated system.
c. micro-sized irrigation water biopumps, water biovalves and/or water biomixers;
d. main water mixing reservoir or growtank and storage tanks for nutrients and pH +/− adjusters; and
e. a connected inline core, for example a single core for the supply of water/water solution or a twin core for the supply of water/water solution, power and/or data feed.

26. A system as claimed in claim 25, in which the programming device comprises at least one of a control board for manual input, data control cards based on smartcard technology, USB and/or infra-red communication.

27. A system as claimed in claim 26, in which the data control cards are programmable by the user.
